(19) United States
(12) Patent Application Publication
(10) Pub. No.: US 2010/0304613 A1
(43) Pub. Date: Dec. 2, 2010

(54) BATTERY UNIT AND ELECTRONIC SYSTEM THEREOF

(76) Inventor: Tai-Seng Lam, Taipei City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 12/472,507

(22) Filed: May 27, 2009

(51) Int. Cl. H01R 24/00; H01M 2/30

(52) U.S. Cl. 439/627; 429/178

(57) ABSTRACT

A battery unit comprises a casing and a battery module disposed inside the casing. The battery module includes a power input/output portion explored from the casing. The power input/output portion has at least one conducting portion and the conducting portion has a positioning structure. The positioning structure and a metal conducting piece of an external electronic device can fix to each other so that the problem of the sudden power-disconnection which is resulted from the shifting of the metal elastic piece or the conducting pin is solved.

### BACKGROUND OF THE INVENTION

1. Field of the Invention

The present invention relates to a battery unit and an electronic system thereof, in particular to a battery unit and an electronic system with improved fixing function.

2. Description of Related Art

The electronic devices are developed in small-size and light-weight. Especially, because laptop computers, mobile communication products and digital cameras are more and more popular, they have to meet the requirement of the high performance and stable performance in the high integrality of these mobile devices. Therefore, the developers focus on reducing the volume of the module, maintaining the high quality and improving the performance of transmission. On the other hand, power supply is focused on as well as the above-mentioned characteristics. The power of the mobile devices is usually supplied by chargeable battery so that users can use these mobile devices in various places.

The traditional battery supplies electrical power by connecting its planar conductive pieces to the pins of the mobile devices. However, user usually uses the device in the moving situations so that the mobile devices are in the states of being shaken, vibrated or dropt on the ground by accident. Thus, the conductive pieces are easily disconnected with the pins due to the vibrations, and the devices are damaged by the sudden power disconnection.

However, the connection between the conductive pieces and the pins is a point-to-point contact, and the problem of huge current density on the contacting point may cause the risk of high temperature.

Therefore, in view of this, the inventor proposes the present invention to overcome the above problems based on his expert experience and deliberate research.

### SUMMARY OF THE INVENTION

The primary object of the present invention is to provide for a battery unit and an electronic system with the battery unit. The conducting portion of the battery unit has a positioning structure thereon so that the metal elastic piece or the conducting pin of the electronic system can be positioned in the positioning structure. Therefore, the problem of the sudden power-disconnection which is resulted from the shifting of the metal elastic piece or the conducting pin is solved.

To achieve the above-mentioned objective, the present invention provides a battery unit. The battery unit comprises a casing and a battery module disposed inside the casing. The battery module includes a power input/output portion explored from the casing. The power input/output portion has at least one conducting portion and the conducting portion has a positioning structure.

The present invention further provides an electronic system containing a battery unit and an electronic device. The battery module includes a power input/output portion explored from the casing. The power input/output portion has at least one conducting portion and the conducting portion has a positioning structure. The electronic device has an outer casing and at least one connecting structure disposed on the outer casing. The connecting structure is corresponding to the conducting portion of the battery unit. When the battery unit is installed with the electronic device, the connecting structure of the electronic device is fixed into the positioning structure of the battery unit.

The positioning structure is formed on the conducting portion of the battery unit so as to fix the connecting structure of the electronic device on the positioning structure. Thus, the battery unit will not shift related to the electronic device so that the problem sudden power-disconnection is solved. On the other hand, the electronic device can be a charger and the problem of stopping the charging procedure due to the shifting of the batter unit is also solved.

In order to further understand the techniques, means and effects the present invention takes for achieving the prescribed objectives, the following detailed descriptions and appended drawings are hereby referred, such that, through which, the purposes, features and aspects of the present invention can be thoroughly and concretely appreciated; however, the appended drawings are merely provided for reference and illustration, without any intention to be used for limiting the present invention.

### BRIEF DESCRIPTION OF THE DRAWINGS

FIG. 1 shows the battery unit according to the present invention.

FIG. 1A shows the first embodiment of the positioning structure of the battery unit according to the present invention.

FIG. 1B shows the first embodiment of the positioning structure of the battery unit according to the present invention.

FIG. 2 shows the explored view of the battery unit and the electronic device according to the present invention.

FIG. 3 shows that the metal elastic piece of the electronic device is fixed in the positioning structure of the battery unit according to the present invention.

FIG. 3A shows that the conducting pin of the electronic device is fixed in the positioning structure of the battery unit according to the present invention.

### DETAILED DESCRIPTION OF THE PREFERRED EMBODIMENTS

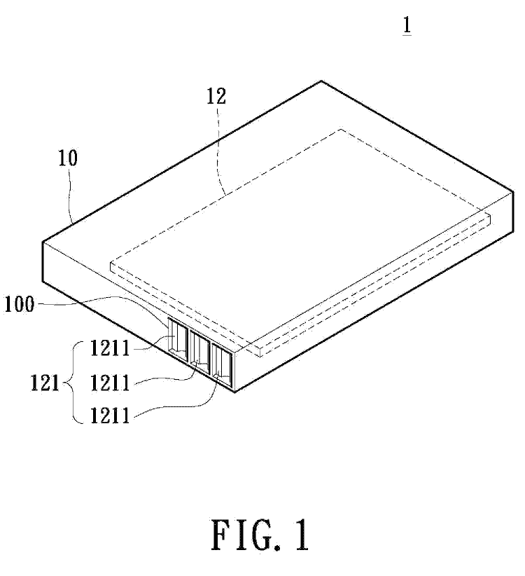

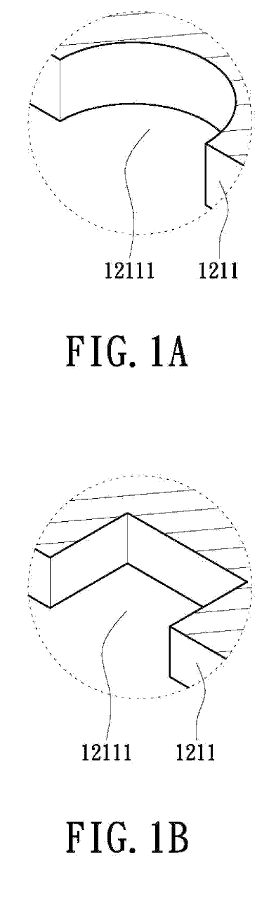

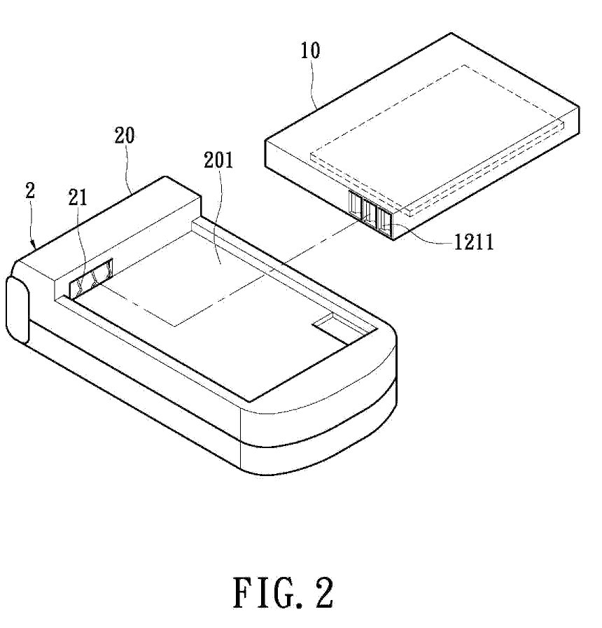

Please refer to FIGS. 1 and 1A; the present invention provides a battery unit 1 which has a positioning and locking structure for preventing the battery unit 1 from shifting when the battery unit 1 is installed with an electronic device. The battery unit 1 has casing 10 and a battery module 12 disposed inside the casing 10. The battery module 12 includes a power input/output portion 121 which is explored from the casing 10 so that the power input/output portion 121 can be used for connecting with another device. Please refer to FIG. 2; the power input/output portion 121 connects electrically with the connecting structure 21 of an electronic device 2 so that the battery unit 1 can provide power source or can be charged. On the other hand, the power input/output portion 121 further has at least one conducting portion 1211 and the conducting portion 1211 has a positioning structure 12111 thereon. The positioning structure 12111 is applied for fixing the connecting structure 21 of an electronic device 2 so that the connecting structure 21 is prevent from the shifting resulted from vibration. Therefore, the electronic device 2 can be in a stable state for function.

Please refer to FIGS. 1 and 1A again; the battery unit 1 has a casing 10 with rectangular solid on the present embodiment and the battery module 12 is disposed inside the casing 10. The battery module 12 has a battery circuit on a PCB (not shown) and the battery module 12 further has a power input/output portion 121 which is constructed by a conductive metal, for example, the power input/output portion 121 is made of a body of conductive metal. The power input/output portion 121 is disposed on a side of the casing 10. The casing 10 has at least one opening 100 on the side thereof and the opening 100 is corresponding to the power input/output portion 121 so that the power input/output portion 121 can be explored from the casing 10. Furthermore, the power input/output portion 121 has at least one conducting portion 1211 for the application. For example, the casing 10 has three openings 100 corresponding to the three conducting portions 1211 of the power input/output portion 121 and the three conducting portions 1211 can perform as a cathode, an anode, or another signal transmission, but not restricted thereby.

The conducting portion 1211 has a positioning structure 12111 by pressing method. In the present embodiment, the positioning structure 12111 is a concave portion. As shown in FIG. 1A, the concave portion has a curving sidewall. Alternatively, the concave portion has polygonal sidewalls as shown in FIG. 1B. Please note that the casing 10 is omitted in FIGS. 1A and 1B for the sake of simplicity. Please refer to FIG. 1 again, the concave portion (i.e., positioning structure 12111) extends in the direction from a side of casing 10 to the opposite side of the casing 10 and the concave portion has a predetermined depth for fixing the connecting structure 21 therein. However, the positioning structure 12111 can be optionally formed on the conducting portion 1211. In other words, the positioning structure 12111 is not necessary formed on each conducting portion 1211. For example, the right and the left conducting portion 1211 has the positioning structure 12111, but the middle conducting portion 1211 is a traditional one. Alternatively, the middle conducting portion 1211 has the positioning structure 12111, but the right and the left conducting portion 1211 are traditional. Therefore, the positioning structure 12111 can be adjusted depending on the different application.

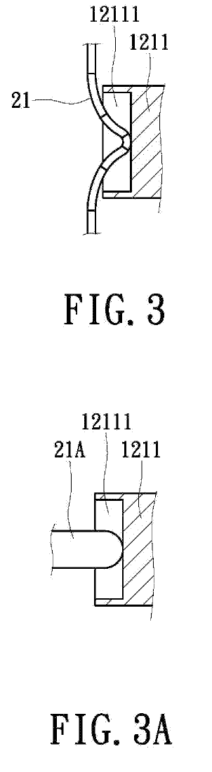

Please refer to FIG. 2; a battery unit 1 is installed on an electronic device 2. The electronic device 2 has an outer casing 20 and at least one connecting structure 21 disposed on the outer casing 20. The connecting structure 21 is corresponding to the conducting portion 1211 for connecting with each other. In other words, the number and the structure of the connecting structure 21 are corresponding to that of the conducting portion 1211. When the battery unit 1 is installed on the electronic device 2, each connecting structure 21 connects to the corresponding conducting portion 1211 and the connecting structure 21 extends into the positioning structure 12111 of the conducting portion 1211 so that the position of the connecting structure 21 is stably fixed. In one embodiment, the electronic device 2 is a portable electronic device, such as a mobile phone, or a laptop computer. The outer casing 20 of the portable electronic device further has a receiving room 201 for accommodating the battery unit 1. The electronic device 2 has three metal elastic pieces (i.e., the connecting structure 21) on the outer casing 20 in accordance with the three conducting portion 1211 of FIG. 1. When user puts the battery unit 1 into the receiving room 201 of the outer casing 20, the metal elastic piece of the electronic device 2 connects electrically to the corresponding conducting portion 1211 of the battery unit 1 so that the battery unit 1 provides electrical power to the electronic device 2. The front portion of the metal elastic piece can insert in to the concave portion (i.e., the positioning structure 12111). Thereby, the metal elastic piece is fixed in the concave portion, as shown in FIG. 3. When user move the electronic device 2 or drop the electronic device 2 accidentally, the connecting structure 21 can contact the conducting portion 1211 stably due to the fixing between the connecting structure 21 and the positioning structure 12111. Therefore, the problem of power disconnection resulted from the shifting of the connecting structure 21 is solved.

On the other hand, the connecting structure 21 can be a conducting pin 21A in another embodiment as shown in FIG. 3A. Each conducting pin 21A connects to the corresponding conducting portion 1211 and the conducting pin 21A elastically extends into the positioning structure 12111 of the conducting portion 1211 so that the position of the conducting pin 21A is stably fixed. In addition, the present invention can provide the improved stability when the battery unit 1 is installed on a charger for being charged. In other words, the battery unit 1 can be stably disposed on a charger via the connecting structure 21 and the positioning structure 12111. Thus, the problem of stopping charging for the battery unit 1 due to the disconnection of the battery unit 1 and the charger resulted from a vibration can be solved.

Regarding the mobile phone, the mobile phone further has inserting socket on the case thereof for inserting a power adapter for charging the phone or inserting a transmission cable for transmitting data. Therefore, the conductive piece on the inserting socket can has a concave portion (i.e., the positioning structure 12111) according to the present invention. When user inserts a power adapter on the inserting socket, the metal piece or pin can be fixed into the concave portion. Therefore, the metal piece or pin can contact the conductive piece with improved stability of the connection and the problem of disconnection resulted from vibration is solved.

In summary, the present invention has the following advantages.

1. The present invention provides for improved stability of connection between the connecting structure of electronic device and the conducting portion of the battery unit. Because of the assembling structure of the connecting structure of electronic device and the conducting portion of the battery unit, the connecting structure can be fixed in the conducting portion when the electronic device is installed with the battery unit. Therefore, the battery unit does not shift relative to the electronic device resulted from the vibration or collision so that the problem of power disconnection is solved.

2. The connection of the connecting structure of electronic device and the conducting portion of the battery unit has larger contacting area. Therefore, the quality of transmission of power or signal is further improved.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

1. A battery unit comprising:
a casing; and
a battery module disposed inside the casing, the battery module including a power input/output port exposed from the casing,
wherein the power input/output port has at least one conducting member, and
wherein the conducting member comprises a positioning structure on the conducting surface thereof.

2. The battery unit according to claim 1, wherein the positioning structure is concave.

3. The battery unit according to claim 2, wherein the concave positioning structure comprises a curving sidewall or polygonal sidewalls.

4. The battery unit according to claim 2, wherein the concave surface of the conducting member has a predetermined depth.

5. An electronic system comprising:
a battery unit comprising:
a battery casing; and
a battery module disposed inside the casing, the battery module including a power input/output port exposed from the casing,
wherein the power input/output port has at least one conducting member, and
wherein the conducting member comprises a positioning structure on the conducting surface thereof; and
an electronic device comprising:
a device casing; and
at least one conductive connecting structure disposed on the device casing,
wherein the connecting structure corresponds to the conducting member of the battery unit,
whereby when the battery unit is installed in the electronic device, the connecting structure of the electronic device engages the positioning structure of the battery unit.

6. The electronic system according to claim 5, wherein the positioning structure is concave.

7. The electronic system according to claim 6, wherein the concave portion has a curving sidewall or polygonal sidewalls.

8. The electronic system according to claim 6, wherein the concave surface of the conducting member has a predetermined depth.

9. The electronic system according to claim 6, wherein the connecting structure is a metal elastic piece or a conducting pin, and wherein the metal elastic piece or the conducting pin is fixed into the concave portion when the battery unit is installed with the electronic device.

10. The electronic system according to claim 5, wherein the electronic device is a power charger or a portable electronic device.

11. The electronic system according to claim 5, wherein the electronic device further has a receiving room for accommodating the battery unit.
